(19) United States
(12) Patent Application Publication
(10) Pub. No.: US 2024/0149218 A1
(43) Pub. Date: May 9, 2024

(54) CATALYST FOR REMOVING NITROGEN OXIDES AND MANUFACTURING METHOD THEREOF

(71) Applicants: SEOUL NATIONAL UNIVERSITY R&DB FOUNDATION, Seoul (KR); KOREA UNIVERSITY RESEARCH AND BUSINESS FOUNDATION, Seoul (KR)

(72) Inventors: Do Heui KIM, Seoul (KR); Se Won JEON, Seoul (KR); Inhak SONG, Seoul (KR); Kwan-Young LEE, Seoul (KR)

(21) Appl. No.: 18/490,210

(22) Filed: Oct. 19, 2023

(30) Foreign Application Priority Data
Nov. 8, 2022 (KR) 10-2022-0148259

(51) Int. Cl. B01D 53/86; B01J 23/22; B01J 29/08; B01J 37/00

(52) U.S. Cl. CPC B01D 53/8628; B01J 23/22; B01J 29/084; B01J 37/0036; B01J 2229/186; B01J 2229/32

(57) ABSTRACT

A catalyst for removing nitrogen oxides and a manufacturing method thereof are provided. The catalyst for removing nitrogen oxides according to embodiments of the present invention is manufactured by mixing and grinding a metal catalyst and a zeolite. The zeolite has a carbon layer formed on the surface of the zeolite. The manufacturing method of a catalyst for removing nitrogen oxides according to embodiments of the present invention comprises preparing a zeolite, forming a carbon layer on the surface of the zeolite, and mixing and grinding the zeolite having the carbon layer with a metal catalyst.

### CROSS-REFERENCE TO RELATED APPLICATIONS

This application claims priority to and benefit of Korean Patent Application No. 10-2022-0148259 filed on Nov. 8, 2022, the disclosure of which is hereby incorporated by reference in its entirety.

### BACKGROUND OF THE INVENTION

### 1. Field of the Invention

The present invention relates to a catalyst for removing nitrogen oxides and a manufacturing method thereof.

### 2. Description of the Related Art

The selective catalytic reduction of nitrogen oxides (NOx) with NH₃ (NH₃-SCR) is a technology for removing harmful NOx species from industrial emissions. Among the reported SCR catalysts, V₂O₅—WO₃/TiO₂ is the only catalyst that is not chemically poisoned by the sulfur component of exhaust gas. However, even these V-based catalysts are deactivated under practical conditions by the physical poisoning arising from the condensation of ammonium bisulfate (ABS) in the pores at low temperatures below 250° C., which lowers the low-temperature activity of SCR catalysts.

### SUMMARY OF THE INVENTION

The present invention provides a catalyst for removing nitrogen oxides with good performance.

The present invention provides a manufacturing method of the catalyst for removing nitrogen oxides.

The other objects of the present invention will be clearly understood with reference to the following detailed description and the accompanying drawings.

A catalyst for removing nitrogen oxides according to embodiments of the present invention is manufactured by mixing and grinding a metal catalyst and a zeolite. The zeolite has a carbon layer formed on the surface of the zeolite.

A manufacturing method of a catalyst for removing nitrogen oxides according to embodiments of the present invention comprises preparing a zeolite, forming a carbon layer on the surface of the zeolite, and mixing and grinding the zeolite having the carbon layer with a metal catalyst.

The catalyst for removing nitrogen oxides according to embodiments of the present invention can have good performance. For example, the catalyst for removing nitrogen oxides can have good sulfur resistance (SO₂ resistance) while preventing a decrease in catalytic activity (SCR activity).

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the NH₃-SCR activity at 220° C. of VWTi catalyst and VWTi+Y catalyst deactivated for 22 hours through ABS formation.

FIG. 2 shows the steady-state NOx conversion of VWTi catalyst and VWTi+Y catalyst depending on temperature during a standard NH₃-SCR reaction.

FIG. 3 shows the effect of the mass ratio of VWTi to Y zeolite on the catalytic activity in the VWTi+Y catalyst.

FIG. 4 shows the solid-state ²⁹Si NMR spectra of the VWTi+Y-5.1 catalyst without grinding and after mechanical grinding.

FIG. 5 shows the solid-state ²⁷Al NMR spectra of the VWTi+Y-5.1 catalyst without grinding and after mechanical grinding.

FIG. 6 shows the solid-state ⁵¹V NMR spectra of the VWTi+Y-5.1 catalyst without grinding and after mechanical grinding.

FIG. 7 shows TEM images and EDS line scanning spectra for the VWTi+Y-12 catalyst and the VWTi+Y-5.1 catalyst after grinding.

FIG. 8 shows H₂-TPR results comparing the effect of mechanical grinding on the VWTi+Y-5.1 catalyst and the VWTi+Y-catalyst.

FIG. 9 shows H₂-TPR results for the Al-impregnated VWTi catalysts.

FIG. 10 shows the results of kinetic analysis of the VWTi catalyst and the VWTi+Y-5.1 catalyst under dry and wet reaction conditions.

FIG. 11 is a drawing for explaining a manufacturing method of a catalyst for removing nitrogen oxides according to an embodiment of the present invention.

FIG. 12 shows ⁵¹V solid state NMR spectra of the VWTi catalyst and the VWTi+OTSY-5.1 catalyst.

FIG. 13 shows H₂-TPR results for the VWTi catalyst and the VWTi+OTSY-5.1 catalyst.

FIG. 14 shows steady-state NOx conversions as a function of temperature during the standard NH₃-SCR reaction for the VWTi+OTSY-5.1 catalyst and its calcined form (VWTi+SY-5.1).

FIG. 15 shows NOx conversion in NH₃-SCR reaction at 220° C. during deactivation for 44 hours by forming ABS on the catalysts.

FIG. 16 shows NOx conversion in NH₃-SCR reaction at 180° C. during deactivation for 44 hours by forming ABS on the VWTi catalyst and the VWTi+OTSY-5.1 catalyst.

### DESCRIPTION OF SPECIFIC EMBODIMENTS

Hereinafter, a detailed description will be given of the present invention with reference to the following embodiments. The purposes, features, and advantages of the present invention will be easily understood through the following embodiments. The present invention is not limited to such embodiments, but may be modified in other forms. The embodiments to be described below are nothing but the ones provided to bring the disclosure of the present invention to perfection and assist those skilled in the art to completely understand the present invention. Therefore, the following embodiments are not to be construed as limiting the present invention.

It will be understood that when an element is referred to as being “on” another element, it can be directly on the other element or intervening elements may be present therebetween.

The size of the element or the relative sizes between elements in the drawings may be shown to be exaggerated for more clear understanding of the present invention. In addition, the shape of the elements shown in the drawings may be somewhat changed by variation of the manufacturing process or the like. Accordingly, the embodiments disclosed herein are not to be limited to the shapes shown in the drawings unless otherwise stated, and it is to be understood to include a certain amount of variation.

The terminology used herein is for the purpose of describing particular embodiments only and is not intended to limit the invention. It is to be understood that the singular forms “a,” “an,” and “the” include plural references unless the context clearly dictates otherwise. It will be further understood that the terms “comprises” or “has,” when used in this specification, specify the presence of stated features, integers, steps, operations, elements, and/or components, but do not preclude the presence or addition of one or more other features, integers, steps, operations, elements, components, and/or groups thereof.

A catalyst for removing nitrogen oxides according to embodiments of the present invention is manufactured by mixing and grinding a metal catalyst and a zeolite. The zeolite has a carbon layer formed on the surface of the zeolite.

The metal catalyst may comprise vanadium (V), and the zeolite may comprise a Y zeolite.

The carbon layer may be formed by reacting an organosilane compound with a hydroxyl group on the surface of the zeolite. The organosilane compound may comprise octadecyltrichlorosilane.

A manufacturing method of a catalyst for removing nitrogen oxides according to embodiments of the present invention comprises preparing a zeolite, forming a carbon layer on the surface of the zeolite, and mixing and grinding the zeolite having the carbon layer with a metal catalyst.

The metal catalyst may comprise vanadium (V), and the zeolite may comprise a Y zeolite.

The forming of the carbon layer may comprise providing an organosilane compound to the zeolite, and the organosilane compound may react with a hydroxyl group on the surface of the zeolite. The organosilane compound may comprise octadecyltrichlorosilane.

[Manufacture Example of a Catalyst for Removing Nitrogen Oxides]

The catalysts for removing nitrogen oxides according to embodiments of the present invention and the catalysts of comparative examples were prepared as follows.

The V₂O₅/WO₃—TiO₂ (VWTi) catalyst containing 5 wt. % V₂O₅ was prepared by the wetness impregnation method. An acidic vanadium precursor solution was prepared by dissolving 0.647 g of ammonium metavanadate (99%) and 0.6 g of oxalic acid in 250 mL of distilled water. The WO₃—TiO₂ support was added to the vanadium precursor solution and vigorously mixed for 30 min. The yellowish colloidal solution was dried using a rotary evaporator at 80° C. and, dried in an oven at 105° C. The resulting powder was calcined in an electronic furnace at 500° C. for 4 h.

The VWTi+Y zeolite hybrid catalyst was prepared by mixing and grinding the VWTi catalyst and Y-zeolite (FAU structure, Si:Al₂=5.1 or 12) in a porcelain mortar for 10 min. The ratios of VWTi to Y zeolite were 2:1, 16:1, 64:1 in mass ratio.

To prepare the Al-VWTi catalyst, the requisite quantity of Al(NO₃)₃·9H₂O was dissolved in distilled water and then deposited on the VWTi catalyst using the incipient wetness impregnation method. The molar ratios of Al to V were 0.5, 1, 2. After impregnation, the samples were calcined in static air at 500° C. for 1 h.

To prepare octadecyltrichlorosilane-coated Y zeolite (OTSY), Y-5.1 zeolite (1 g, Si:Al₂=5.1) was dispersed in 20 mL of toluene and sonicated for 10 min. 0.591 mL of octadecyltrichlorosilane (OTS) was dissolved in 50 mL of toluene solvent. The dispersed Y-5.1 zeolite was added to the OTS-toluene solution and stirred at 30° C. for 24 h. The suspension was filtered through filter paper and washed with ethanol several times. The resulting white powder was dried in an oven overnight at 105° C. and OTSY-5.1 zeolite was formed.

To prepare a hydrocarbon-modified-Y zeolite composite, which was used as for comparison to OTSY-zeolite, starch powder was used. 0.18 g of starch and 1 mL of NH₄OH were added to distilled water (250 mL) and allowed to swell for 4 h at 90° C. 2.5 g of Y zeolite was added, stirred for 1 h, and dried using a rotary evaporator. The obtained composite (starch-Y) was dried in an oven overnight at 105° C. The amounts of carbon in OTSY-5.1 zeolite (2.8 wt. %) and starch-Y-5.1 (2.2 wt. %) were comparable, as determined by elemental analysis.

[Catalytic Reaction System]

The catalytic activities of the various catalysts for NH₃-SCR reaction were measured in a 0.25-inch tubular quartz reactor. All catalysts were pelletized and sieved to 180-250 μm to prevent pressure drop and to ensure data reproducibility. The simulated reaction feed contained 500 ppm NO, 600 ppm NH₃, 10% O₂, 5% CO₂, 10% H₂O (deionized), and or 100 ppm SO₂ balanced with N₂. The gas hourly space velocity (GHSV) was 150,000 mL/h·g_{cat}. The GHSV was set based on the weight of the VWTi catalyst (0.08 g) in the case of the mechanically mixed hybrid catalysts (0.08 g VWTi+Y-zeolite 0.04 g). The total flow rate was fixed to 200 mL/min. The NOx concentrations were recorded using a NOx chemiluminescence analyzer, and the NOx conversion was calculated using the following equation.

$$NOx conversion ( \% ) = \frac{{[ NOx ]}_{in} - {[ NOx ]}_{out}}{{[ NOx ]}_{in}} \times 100$$

To simulate ABS deactivation in the presence of SO₂ and H₂O, the catalysts were exposed for either 22 or 44 h under the above reaction conditions to 30 or 100 ppm SO₂ at 180 or 220° C. The catalyst deactivation on the formation of ABS increases as the concentration of SO₂ increases and the reaction temperature decreases. When regenerating catalysts by decomposing ABS species, the catalysts were heated at 350° C. for 2 h under 10% O₂, 5% CO₂, and 10% H₂O balanced with N₂.

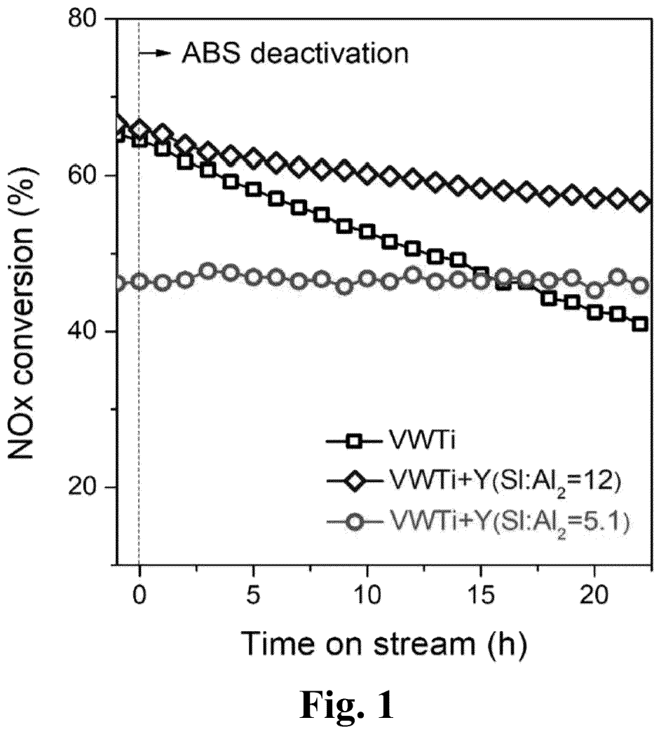

FIG. 1 shows the NH₃-SCR activity at 220° C. of VWTi catalyst and VWTi+Y catalyst deactivated for 22 hours through ABS formation. The mass ratio of VWTi to Y-zeolite in the VWTi+Y catalyst was 2:1. A well-mixed catalyst was formed by mechanical mixing and grinding of VWTi catalyst and Y zeolite. The two different particles, zeolite and TiO₂, can be easily distinguished because of their different sizes. Zeolite has a size of hundreds of nanometers, while TiO₂ particles are very small, tens of nanometers. The reaction feed contained 500 ppm NO, 600 ppm NH₃, 10% O₂, 5% CO₂, 10% H₂O, and 30 ppm SO₂ balanced with N₂ at a GHSV of 150,000 mL/g-h.

Referring to FIG. 1, the VWTi catalyst shows deactivated catalytic activity at low temperature (220° C.) in the presence of ABS. The initial NOx conversion rate was 65%, but gradually decreased to about 40% after 22 hours. The initial activity of the VWTi+Y catalyst prepared by mixing Y zeolite with a Si:Al₂ ratio of approximately 12 and VWTi was similar to that of the VWTi catalyst, but the ABS deactivation proceeded much more slowly due to the ABS trapping ability of the zeolite particles in the VWTi+Y catalyst.

The Al-rich Y-zeolite (Si:Al₂ of approximately 5.1) showed totally different behavior when mixed with the VWTi catalyst. Although the initial activity dropped significantly from 65% to 45%, this initial activity was retained for 22 h without any decrease in the NOx conversion. The superior sulfur resistance of the VWTi+Y catalyst is attributed to the fact that Al-rich zeolite can more efficiently absorb ABS from VWTi surface compared to common zeolite. The sizes of the particles of the Y-5.1 (Si:Al₂ of approximately 5.1) and Y-12 (Si:Al₂ of approximately 12) zeolites are almost identical, meaning that there is no difference in physically contacted area between zeolite and VWTi particles. Thus, the only difference is the abundant acidic sites in the Al-rich zeolite that promote the migration of ABS.

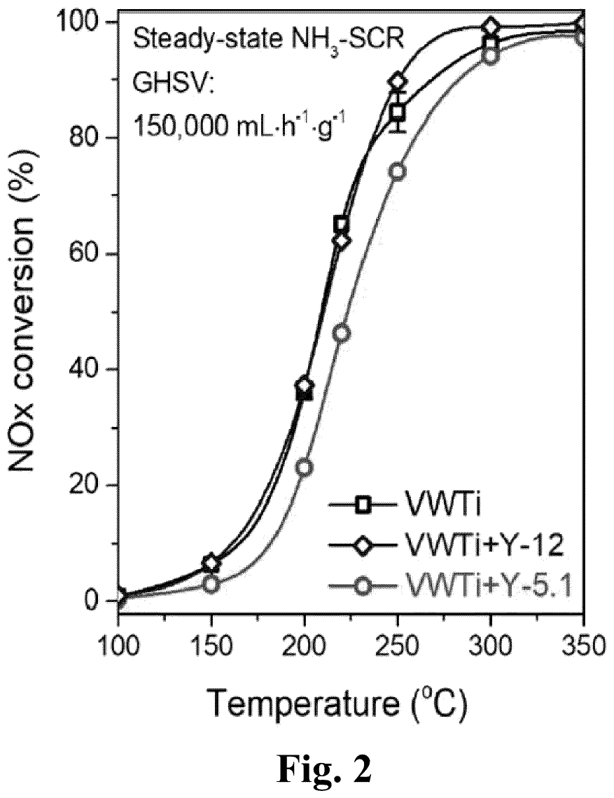

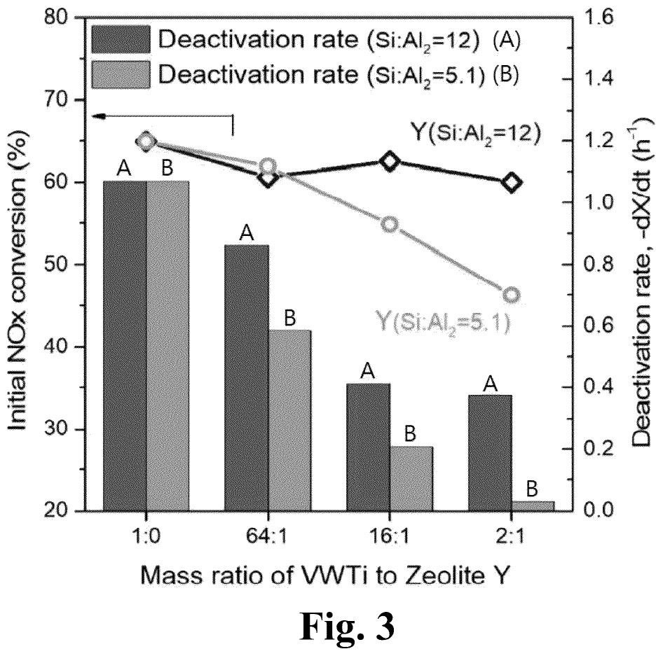

FIG. 2 shows the steady-state NOx conversion of VWTi catalyst and VWTi+Y catalyst depending on temperature during a standard NH₃-SCR reaction. To identify the cause of the decrease in the initial activity of the VWTi+Y-5.1 catalyst, the steady-state activities of the catalysts were compared over a wide temperature range. FIG. 3 shows the effect of the mass ratio of VWTi to Y zeolite on the catalytic activity in the VWTi+Y catalyst. The mixing ratios of VWTi to Y zeolite were varied to determine whether the catalyst deactivation resulting from grinding was caused by the Al-rich zeolite. The reaction feed contained 500 ppm NO, 600 ppm NH₃, 10% O₂, 5% CO₂, and 10% H₂O balanced with N₂ at a GHSV of 150,000 mL/g-h.

Referring to FIG. 2, the mechanical mixing of Y-5.1 zeolite caused some degradation in the activity of the VWTi catalyst over the whole temperature range (150-350° C.), whereas the mixing of the Y-12 zeolite had little effect on the SCR performance.

Referring to FIG. 3, for the VWTi+Y-12 catalyst, the initial activity of the catalyst decreased slightly at a mass ratio of 64 to 1, but a certain degree of the initial catalytic activity was maintained regardless of the mixing ratios. However, as more Y-5.1 zeolite was added, the NOx conversion gradually decreased, and the SO₂ resistance continuously increased. The amount of Al-rich Y-zeolite mixed with VWTi have such a significant impact on the catalytic activity and ABS trapping ability at the same time, and the Al species in the zeolite, which provide sulfur resistance, are also the cause of the deterioration of the initial catalyst activity.

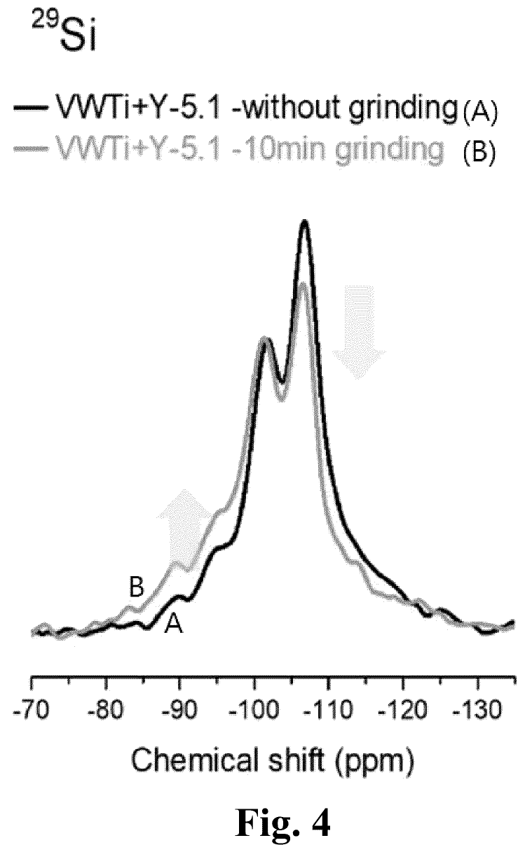

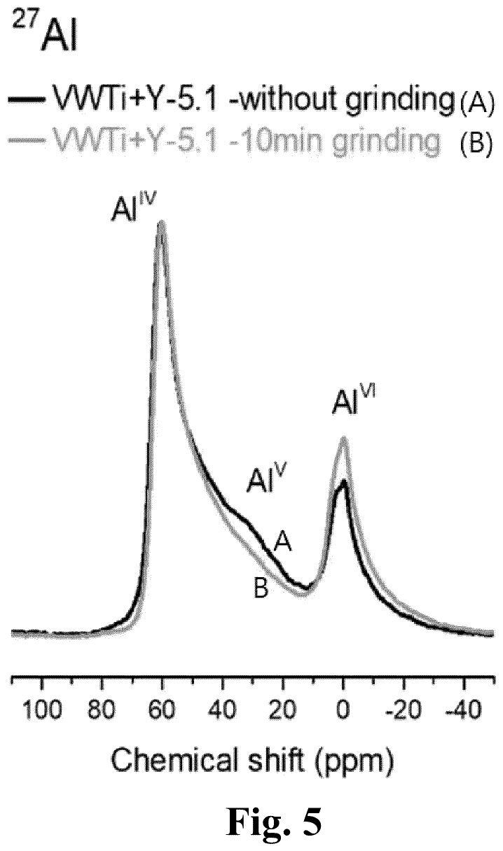

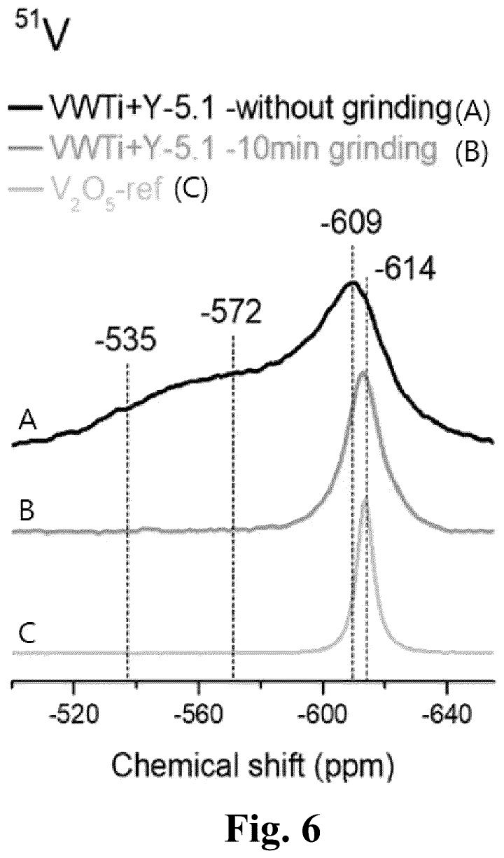

FIGS. 4 to 6 show the solid-state ²⁹Si, ²⁷Al, and ⁵¹V NMR spectra of the VWTi+Y-5.1 catalyst without grinding and after mechanical grinding. The mass ratio of VWTi to Y-5.1 zeolite was 2:1, and the VWTi+Y-5.1 catalyst without grinding was prepared by mixing the two materials in a vial by handshaking. To investigate the cause of abnormal catalyst deactivation after physical mixing, Al-rich Y-5.1 and VWTi were pulverized and the physicochemical changes in the materials were analyzed through various characterization methods.

Referring to FIGS. 4 to 6, the ²⁹Si-NMR spectra revealed a decrease in the intensity of the peak at −107 ppm, which corresponds to the tetrahedral coordinated framework of the Si—O groups, whereas the increase in the peaks at chemical shifts of −90 and −95 ppm can be attributed to Si—O groups surrounded by 3 or 2 Al. The ²⁷Al-NMR spectrum showed an increase in the peak corresponding to Al^{VI} in the extra-framework Al (0 ppm) and a slight decrease in the intensity of the Al^{V} peak corresponding to the extra-framework Al (EFAl), indicating a decrease in four-coordinated EFAl and an increase in six-coordinated EFAl species after grinding. This change means that some of the EFAl species are converted back to framework Al species on grinding, even under ambient conditions. The application of mechanical force to the catalyst can induce the structural rearrangement of framework-associated Al or the movement of EFAl species in the zeolite cage.

Mechanical grinding had a significant effect on the coordination environment of the vanadium species, as well as the Al species. The peaks of the highly dispersed isolated monomeric VOx species (−535 and −572 ppm) on the TiO2 surface almost disappeared after grinding, and only the peak at −614 ppm corresponding to oligomeric VOx or nano-sized V₂O₅ remained after grinding. The observation of the simultaneous decrease in the dispersed VOx species and the change in the Al species in the zeolite structure indicates that mechanical grinding induces interactions between V and Al species, possibly because of the diffusion of mobile Al species to isolated VOx species on the TiO₂ surface. Additionally, the amount of NH₃ desorption at low temperatures decreased after grinding, whereas the number of acid sites at high temperatures increased.

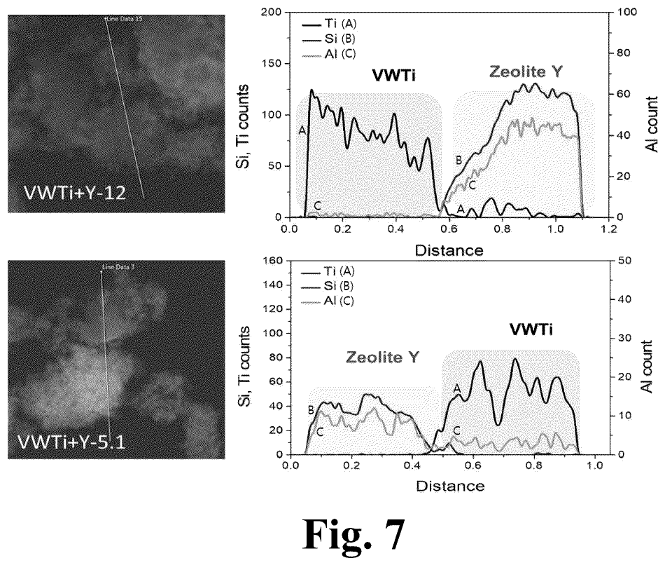

FIG. 7 shows TEM images and EDS line scanning spectra for the VWTi+Y-12 catalyst and the VWTi+Y-5.1 catalyst after grinding. The mass ratio of VWTi to Y zeolite was 2:1

Referring to FIG. 7, a portion of the VWTi particles contain a significant amount of Al after mechanical mixing. These observations indicate the possibility of EFAl migration and subsequent interactions with the isolated V sites as a result of the grinding process.

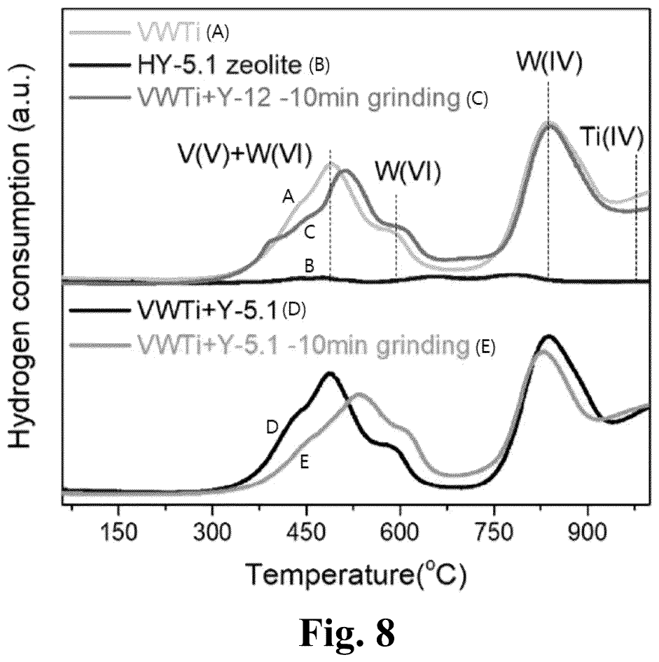

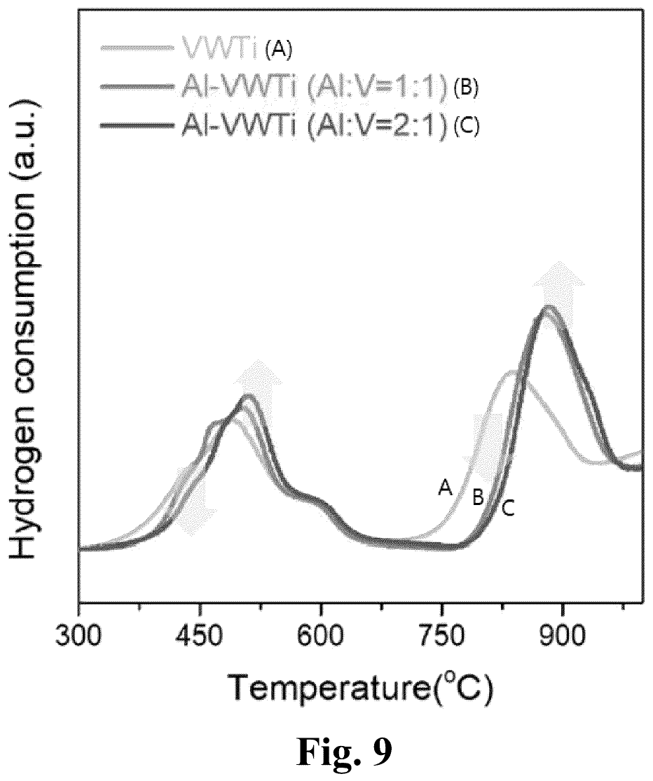

FIG. 8 shows H₂-TPR results comparing the effect of mechanical grinding on the VWTi+Y-5.1 catalyst and the VWTi+Y-catalyst, and FIG. 9 shows H₂-TPR results for the Al-impregnated VWTi catalysts.

Referring to FIG. 8, the changes in the Al species resulting from the mechanical interactions of the VWTi+Y-5.1 zeolite induced changes in the redox behavior of isolated V sites. In the H₂-TPR profiles, the overall reduction peak at 370-620° C., which was assigned to the reduction of dispersed VOx and WOx species, shifted to a higher temperature after grinding. The use of Y-5.1 zeolite resulted in more pronounced changes in the reduction temperature in the mixed VWTi catalyst compared to that of Y-12 zeolite. Such a significant change in the reducibility of the isolated VOx species can only be explained by chemical interaction with Al species, which inhibit the reduction of V-O-Ti by forming Al—O bonds.

Referring to FIG. 9, to confirm the potential effects of Al species on the reducibility of VOx, the Al(NO₃)₃ solution was impregnated on the VWTi catalyst to simulate the migration of Al and the changes in the H₂-TPR results were observed. A similar trend was observed for the Al-impregnated VWTi catalysts in which the reduction peak below 450° C. decreased, whereas the peak above 500° C. increased as more Al was impregnated. These results indicates that the diffused Al species originating from the zeolite affect the reducibility of the VOx species on TiO₂ by grinding process.

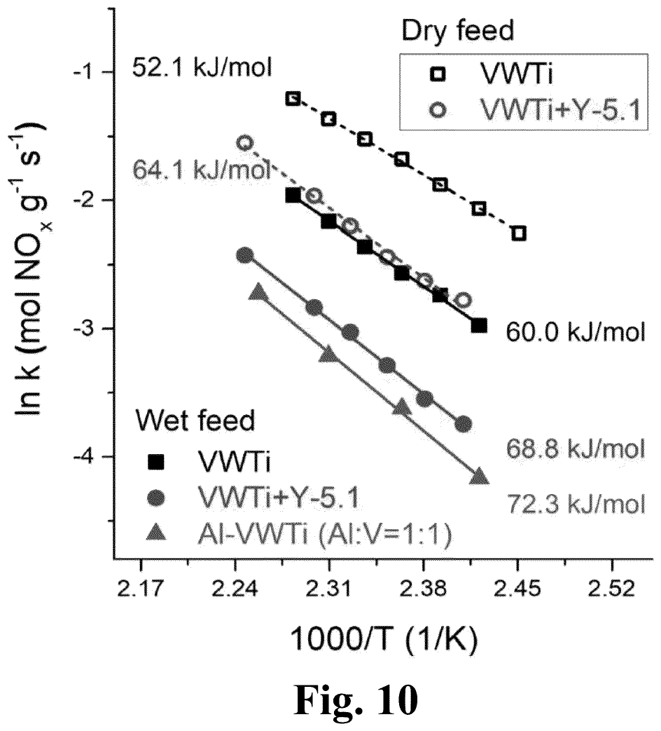

FIG. 10 shows the results of kinetic analysis of the VWTi catalyst and the VWTi+Y-5.1 catalyst under dry and wet reaction conditions. The kinetic analysis of the catalyst was performed to examine the effects of the VOx-Al interaction on the reaction pathway in the SCR reaction. The mass ratio of VWTi to Y-5.1 zeolite was 2:1

Referring to FIG. 10, the activation energy (Ea) of the VWTi catalyst with the wet feed was measured as approximately kJ/mol under standard SCR conditions. However, after grinding with Y-5.1 zeolite, the Ea increased to approximately kJ/mol. Similarly, under dry conditions, the Ea of VWTi was 52 kJ/mol, whereas that of VWTi+Y-5.1 catalyst increased to 64 kJ/mol, suggesting that the increase in Ea occurs regardless of the presence of water. The changes in the reaction kinetics, represented by an increase in the activation energy, can be explained only by the modulation of active sites of the reaction.

The Ea of the Al-impregnated VWTi catalyst was higher (72 kJ/mol) than that of the VWTi catalyst, similar to the observations for the VWTi+Y-5.1 catalyst. The interaction between V and Al, thus, led to a higher Ea in SCR reaction, which is a major cause of catalytic deactivation after grinding. Surface VOx species on TiO₂ are dynamic under reaction conditions, meaning that changes in the VOx dispersion may cause deactivation after grinding. To confirm this possibility, kinetic analyses of VWTi catalysts with various V loadings were performed under wet conditions, and the Ea was found to be 52-60 kJ/mol regardless of V loading. Therefore, the increase in Ea for the VWTi+Y-5.1 catalyst is attributed to the interaction with Al species rather than the change in V dispersion.

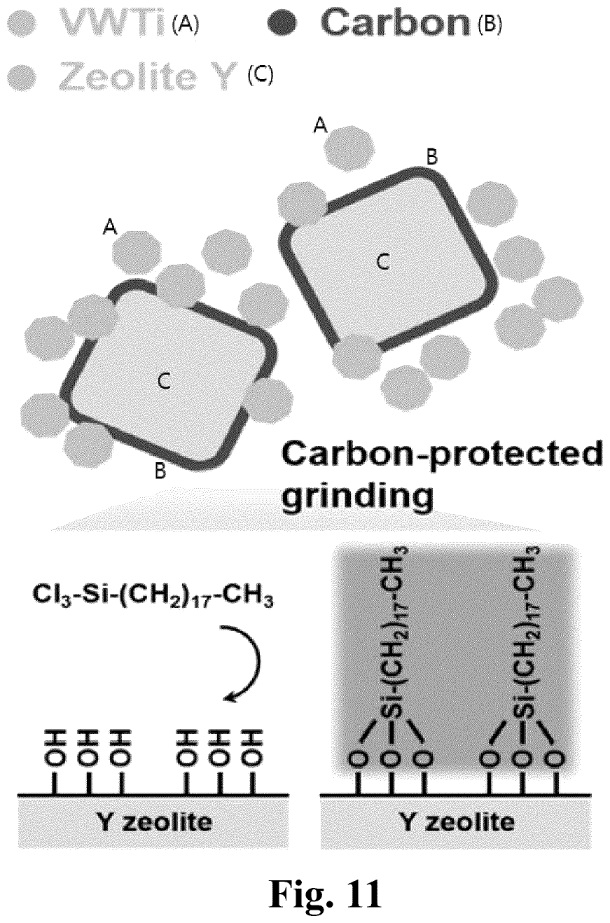

FIG. 11 is a drawing for explaining a manufacturing method of a catalyst for removing nitrogen oxides according to an embodiment of the present invention.

Referring to FIG. 11, before mixing VWTi and Y zeolite, the Y zeolite is coated with a carbon layer. Octadecyltrichlorosilane (OTS) is dissolved in toluene solvent to form an OTS-toluene solution. When the Y zeolite is added to the OTS-toluene solution, the OTS reacts with the hydroxyl group of the Y zeolite to form HCl, and the Y zeolite is coated with the OTS to form an OTS layer (carbon layer) on the surface of the Y zeolite. VWTi+OTSY-5.1 catalyst can be prepared by mixing Y zeolite (OTSY) with an OTS layer and VWTi and then grinding them.

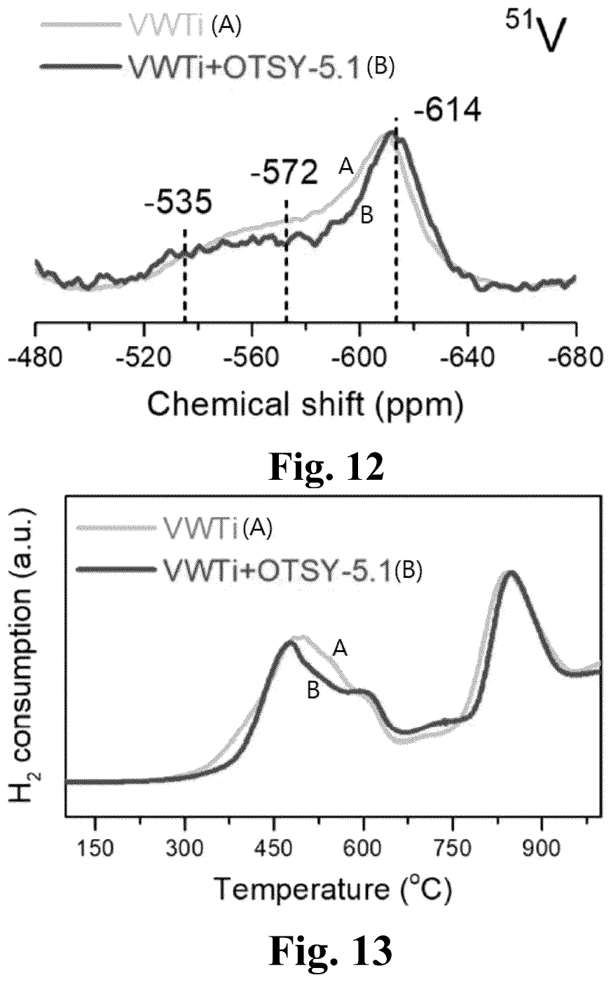

FIG. 12 shows ⁵¹V solid state NMR spectra of the VWTi catalyst and the VWTi+OTSY-5.1 catalyst, and FIG. 13 shows H₂-TPR results for the VWTi catalyst and the VWTi+OTSY-5.1 catalyst.

Referring to FIGS. 12 and 13, the VWTi+OTSY-5.1 catalyst coated with a carbon layer resulted in similar ⁵¹V NMR peak intensities before and after grinding. In addition, the H₂-TPR profiles showed no decrease in the reducibility of VWTi after grinding. These results indicate that isolated VOx is preserved without the interaction of Al species.

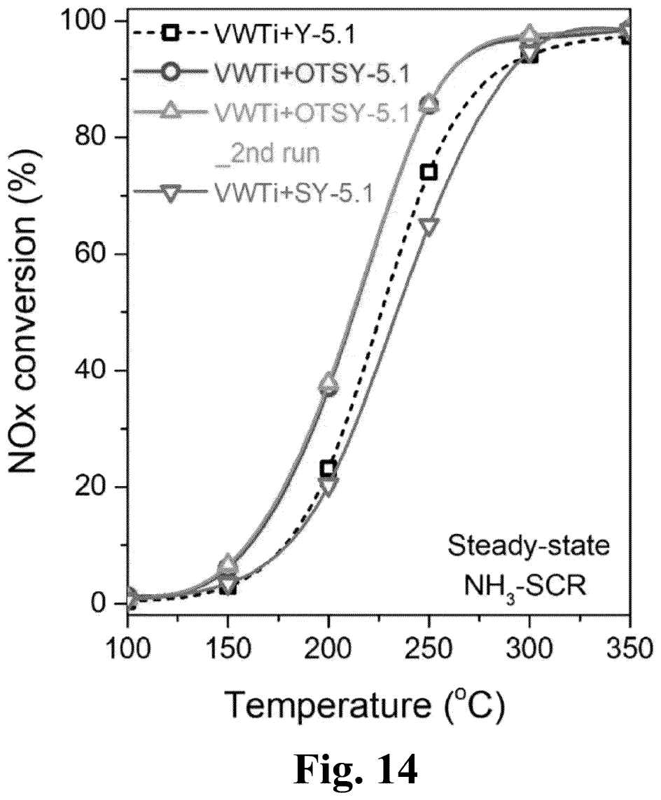

FIG. 14 shows steady-state NOx conversions as a function of temperature during the standard NH₃-SCR reaction for the VWTi+OTSY-5.1 catalyst and its calcined form (VWTi+SY-5.1). The mass ratio of VWTi to OTSY-5.1 in the VWTi+OTSY-5.1 catalyst was 2:1.

Referring to FIG. 14, compared to the VWTi+Y-5.1 catalyst, VWTi+OTSY-5.1 catalyst retained its initial catalytic activity without any deactivation from 100 to 300° C. This clearly shows that thin carbon layers on the external surfaces of zeolite particles effectively act as a physical barrier and prevent the diffusion of Al species, thereby protecting the active isolated VOx sites on the TiO₂ surface. After conducting the SCR reaction over this catalyst up to 500° C., the reactor was cooled to room temperature and retested under the same conditions. In the 2nd SCR test, there should be direct contact between the VWTi and zeolite particles because most of the carbon layer is removed by oxidation. The elemental analysis of the OTSY-5.1 catalyst showed only a small amount of the carbon layer remaining after oxidation at 500° C. The SCR activity was totally maintained without any change in the 2nd SCR test, even though there was direct contact between zeolite and VWTi particles, indicating that chemical deactivation by mobile EFAl species does not occur without the mechanical grinding process. This means that the migration of Al species, mostly EFAl, to adjacent particles is caused by mechanical force rather than differences in the chemical potential. For comparison, a VWTi+SY-5.1 catalyst was prepared to observe what happens if the carbon layer is removed before grinding. SY-5.1 in the VWTi+SY-5.1 catalyst was prepared by pre-oxidizing the carbon-coated OTSY-5.1 at 500° C. In this case, as expected, a decrease in SCR activity was observed again, which is similar to the observations for the VWTi+Y-5.1. This indicates that the remaining silane groups on the zeolite after oxidation cannot prevent the mechanochemical interaction between VOx and Al species. In other words, a thin carbon layer on the zeolite surface that prevents direct contact between V and zeolite must be present.

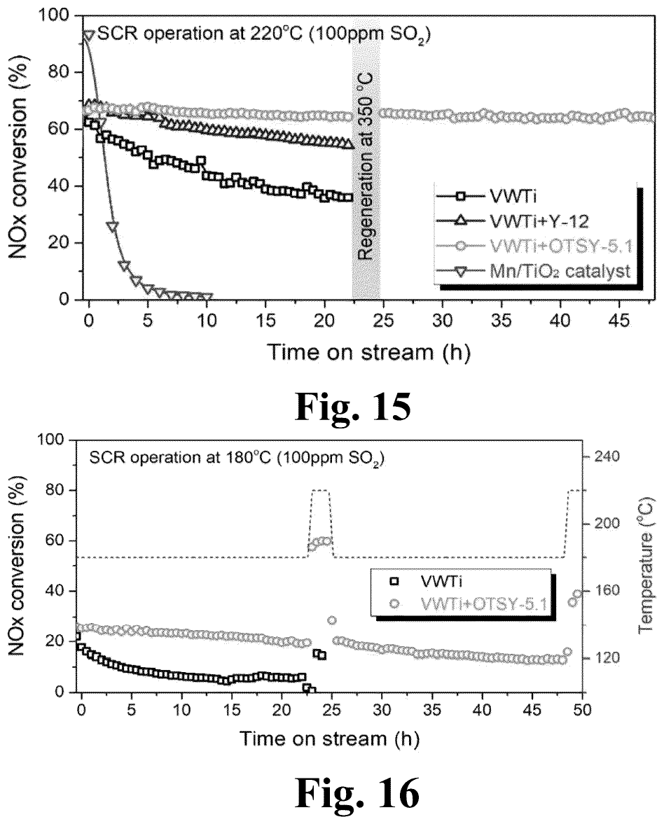

FIG. 15 shows NOx conversion in NH₃-SCR reaction at 220° C. during deactivation for 44 hours by forming ABS on the catalysts. The catalysts were regenerated at 350° C. from 22 to 24 h during operation. The reaction feed contained 500 ppm NO, 600 ppm NH₃, 10% O₂, 5% CO₂, 10% H₂O, and 100 ppm SO₂ balanced with N₂ at a GHSV of 150,000 mL/g-h. FIG. 16 shows NOx conversion in NH₃-SCR reaction at 180° C. during deactivation for 44 hours by forming ABS on the VWTi catalyst and the VWTi+OTSY-5.1 catalyst. The catalysts were heated to 220° C. after 22 and 48 h to monitor the deactivation progress. The mass ratio of VWTi to zeolite in the VWTi+zeolite catalyst was 2:1.

Referring to FIG. 15, the VWTi+OTSY-5.1 catalyst retained its initial catalytic activity without any chemical deactivation arising from EFAl species while successfully maintaining a high SO₂ resistance without any physical deactivation with ABS for 44 h operation. This performance is superior compared to conventional VWTi and Mn-based catalysts and, thus, can be utilized in combustion facilities with sulfur-containing exhaust gas.

Referring to FIG. 16, low temperatures (below 200° C.) can further accelerate ABS deactivation. This is because the vapor pressure of ABS drops substantially as the temperature decreases. Thus, the catalysts were tested at a much lower temperature (180° C.), where the condensation of ABS in the catalyst pores occurred more easily. The conventional VWTi catalyst rapidly lost its activity in 5 h under these conditions and the activity was lower still (below 20%) when temperature was increased to 220° C. because condensed ABS is hard to decompose at this temperature. In contrast, the VWTi+OTSY-5.1 catalyst retained its activity with very little deactivation for 22 h, and the activity was still higher (approximately 60%) when the temperature was recovered to 220° C. It was also confirmed that further low-temperature exposure for 44 h did not completely deactivate the catalyst. These results indicate that the low-temperature events currently occurring during real SCR operation can be prevented.

To confirm whether bulk carbon had a similar effect as a thin carbon layer made of organosilanes, instead of using silane, a bulk carbon compound, colloidal starch in aqueous solution, was deposited on zeolite particles and the zeolite particles were mixed with a VWTi catalyst. In this case, ABS deactivation occurred, and this is because the long colloidal starch ligands induce zeolite agglomeration, thereby inhibiting sufficient VWTi-zeolite contact for ABS trapping, unlike the OTS layer that only covers the external surface of zeolite. This shows that the carbon layer must be carefully introduced without interrupting the essential contact between VWTi and zeolite for efficient ABS trapping.

As above, the exemplary embodiments of the present invention have been described. Those skilled in the art will appreciate that the present invention may be embodied in other specific ways without changing the technical spirit or essential features thereof. Therefore, the embodiments disclosed herein are not restrictive but are illustrative. The scope of the present invention is given by the claims, rather than the specification, and also contains all modifications within the meaning and range equivalent to the claims.

What is claimed is:

1. A catalyst for removing nitrogen oxides manufactured by mixing and grinding a metal catalyst and a zeolite,
wherein the zeolite has a carbon layer formed on the surface of the zeolite.

2. The catalyst for removing nitrogen oxides of claim 1, wherein the metal catalyst comprises vanadium (V), and the zeolite comprises a Y zeolite.

3. The catalyst for removing nitrogen oxides of claim 1, wherein the carbon layer is formed by reacting an organosilane compound with a hydroxyl group on the surface of the zeolite.

4. The catalyst for removing nitrogen oxides of claim 3, wherein the organosilane compound comprises octadecyltrichlorosilane.

5. A manufacturing method of a catalyst for removing nitrogen oxides comprising:
preparing a zeolite;
forming a carbon layer on the surface of the zeolite; and
mixing and grinding the zeolite having the carbon layer with a metal catalyst.

6. The manufacturing method of a catalyst for removing nitrogen oxides of claim 5, wherein the metal catalyst comprises vanadium (V), and the zeolite comprises a Y zeolite.

7. The manufacturing method of a catalyst for removing nitrogen oxides of claim 5, wherein the forming of the carbon layer comprises providing an organosilane compound to the zeolite, and
wherein the organosilane compound reacts with a hydroxyl group on the surface of the zeolite.

8. The manufacturing method of a catalyst for removing nitrogen oxides of claim 7, wherein the organosilane compound comprises octadecyltrichlorosilane.
